(19) United States
(12) Patent Application Publication
(10) Pub. No.: US 2015/0099432 A1
(43) Pub. Date: Apr. 9, 2015

(54) CMP EQUIPMENT USING MAGNET RESPONSIVE COMPOSITES

(71) Applicant: Applied Materials, Inc., Santa Clara, CA (US)

(72) Inventors: Uday MAHAJAN, Singapore (SG); Rajeev BAJAJ, Fremont, CA (US); Fred Conrad REDEKER, Fremont, CA (US); Abdul Wahab MOHAMMED, Singapore (SG)

(21) Appl. No.: 14/484,173

(22) Filed: Sep. 11, 2014

Related U.S. Application Data
(60) Provisional application No. 61/886,633, filed on Oct. 3, 2013.

(51) Int. Cl. B24B 41/04; B24B 37/34; H01F 7/02; B24B 37/20

(52) U.S. Cl. CPC B24B 41/04; B24B 37/20; B24B 37/34; H01F 7/0273
USPC 451/56; 451/495; 335/284

(57) ABSTRACT

Embodiments described herein generally relate to devices and methods for magnetic-responsive chemical mechanical polishing. In one embodiment, a device including a support with one or more magnetic field generators formed therein is provided. The magnetic field generators can produce at least one magnetic field. A magnetic-responsive composite is positioned in magnetic connection with the magnetic field generators. When the magnetic-responsive composite receives the magnetic field from the magnetic field generators, the magnetic-responsive composite changes shape.

### CROSS-REFERENCE TO RELATED APPLICATIONS

This application claims benefit of U.S. Provisional Patent Application Ser. No. 61/886,633 (APPM/21121L), filed Oct. 3, 2013, which is herein incorporated by reference.

### BACKGROUND

1. Field

Embodiments of the invention generally relate to devices and systems utilized in chemical mechanical polishing (CMP) processes. More specifically, embodiments disclosed herein are related to devices for localized control of CMP.

2. Description of the Related Art

Chemical-mechanical polishing (CMP), also known as chemical mechanical planarization, is a process used in the semiconductor fabrication industry to provide flat surfaces on integrated circuits devices. CMP involves pressing a rotating wafer against a rotating polishing pad, while applying polishing fluid or slurry to the pad to affect removal of films or other materials from a substrate. Such polishing is often used to planarize insulating layers, such as silicon oxide and/or metal layers, such as tungsten, aluminum, or copper, that have been previously deposited on the substrate.

CMP is reaching the limits of its capability using current state of the art hardware. One challenge for the process is incoming within-wafer-non-uniformity (WIWNU). The non-uniform stress on the wafer surface during CMP is a major reason for the non-uniform material removal rate which results in the WIWNU. Non-uniform stress can arise from a variety of sources, such as the pressure exerted by the polishing pad, shear stress due to the relative motion between the wafer and pad, from the film deposition or edge bead removal (EBR) non-uniformity. WIWNU can manifest as localized film thickness variation on regions, such as thickness variation between the substrate center and edge. Current CMP hardware is unable to address this localized material non-uniformity effectively.

The above challenges and requirements have led to the investigation of small pad CMP. The use of small pad CMP, though promising, presents significant challenges for process uniformity control due to the small size of the CMP pad (similar to wafer size). Therefore, there is a need for devices and methods to provide better control of local uniformity during CMP.

### SUMMARY

Embodiments described herein generally provide an apparatus employing magnetic-responsive composites for CMP. Magnetic-responsive composites, such as Magnetic-Polymer Composites (MPC), can achieve highly controlled local deformation of the pad and/or wafer surface during CMP. Controlled local deformation of the CMP polishing pad can provide process uniformity improvement which can help to minimize WIWNU.

In one embodiment, a polishing device can include a support with one or more magnetic field generators formed therein, wherein the magnetic field generators produce a magnetic field. A magnetic-responsive composite can be in connection with the magnetic field generators, wherein the magnetic-responsive composite changes shape in response to the magnetic field.

In another embodiment, a polishing device can include a polishing platen, a magnetic-responsive composite formed on the surface of the polishing platen, one or more magnetic field generators in magnetic connection with the magnetic-responsive composite, the magnetic field generators producing one or more magnetic fields, and a polishing pad formed in connection with the magnetic-responsive composite, the polishing pad changing shape with the magnetic-responsive composite.

In another embodiment, a polishing system can include a polishing pad configured to polish a substrate; a support comprising a plurality of magnetic field generators, the magnetic field generators configured to support a substrate or a polishing pad and produce one or more magnetic fields; and a magnetic-responsive composite in connection with the support, the magnetic-responsive composite configured to receive the one or more magnetic fields, change shape or position in response to the magnetic fields and apply a force to a polishing pad or a substrate in response to the change in shape.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a top perspective exploded view of a polishing platen with a magnetic-responsive composite;

FIGS. 1B-1F are top perspective views of a magnetic-responsive composite, according to one or more embodiments;

FIG. 2 depicts a bottom perspective exploded view of a polishing head with a magnetic-responsive composite, according to one embodiment;

FIG. 3A depicts a side sectional view of a polishing system having a magnetic-responsive composite, according to embodiments herein;

FIG. 3B is a force diagram during a processing operation, according to embodiments herein; and

FIG. 4 is a block diagram of a method of polishing a substrate according to one embodiment.

To facilitate understanding, common words have been used, where possible, to designate identical elements that are common to the figures. It is contemplated that elements disclosed in one embodiment may be beneficially utilized on other embodiments without specific recitation.

### DETAILED DESCRIPTION

The present invention relates to polishing articles and methods of manufacture thereof. Magnetic-responsive composites, such as MPCs, can be used to achieve highly controlled local deformation of the pad and/or wafer surface during CMP. An example of an MPC, useable with embodiments described herein, would consist of spherical iron particles embedded in a polysiloxane (silicone) matrix. MPCs, such as ferrogels, can achieve rapid, large and reversible deformation on application of a magnetic field. By controlling the rapid, large and reversible deformation of the MPC or other magnetic-responsive composites, the deformation of the polishing pad and/or wafer can be controlled during CMP.

In one embodiment, the magnetic-responsive composite can be positioned under the polishing pad. Magnetic field generators, such as electromagnets, can be positioned within a specific pattern or layout, such as concentric rings. In this embodiment, the magnetic field generators are embedded in the polishing platen. During the CMP process, a combination of specific magnetic field generators, such as the individual rings of the concentric ring layout, are activated to provide the necessary magnetic field distribution to deform the magnetic-responsive composite. The deformed magnetic-responsive composite will then deform the polishing pad respective to the position of the deformation on the magnetic-responsive composite.

In another embodiment, the magnetic-responsive composite is integrated into the polishing pad. As above, magnetic field generators, such as electromagnets, can be positioned with in a specific pattern or layout, such as concentric rings. In this embodiment, the magnetic field generators are embedded in the polishing platen. During the CMP process, a combination of specific magnetic field generators, such as the individual rings of the concentric ring layout, are activated to provide the necessary magnetic field distribution to deform the integrated magnetic-responsive composite/polishing pad at a desired location.

In another embodiment, the magnetic-responsive composite is integrated into the polishing head or wafer carrier. As above, magnetic field generators, such as electromagnets, can be positioned with in a specific pattern or layout, such as concentric rings. In this embodiment, the magnetic field generators are embedded in the polishing head above the magnetic-responsive composite. During the CMP process, a combination of individual rings is activated to provide the necessary magnetic field distribution to deform the magnetic-responsive composite. The deformed magnetic-responsive composite then pressurizes the wafer locally based on the location of the deformation in the magnetic-responsive composite. The benefits of this approach include enabling a simplified polishing head design with potentially faster zone control response and allowing for zone control in the main polish module and small pad buff step.

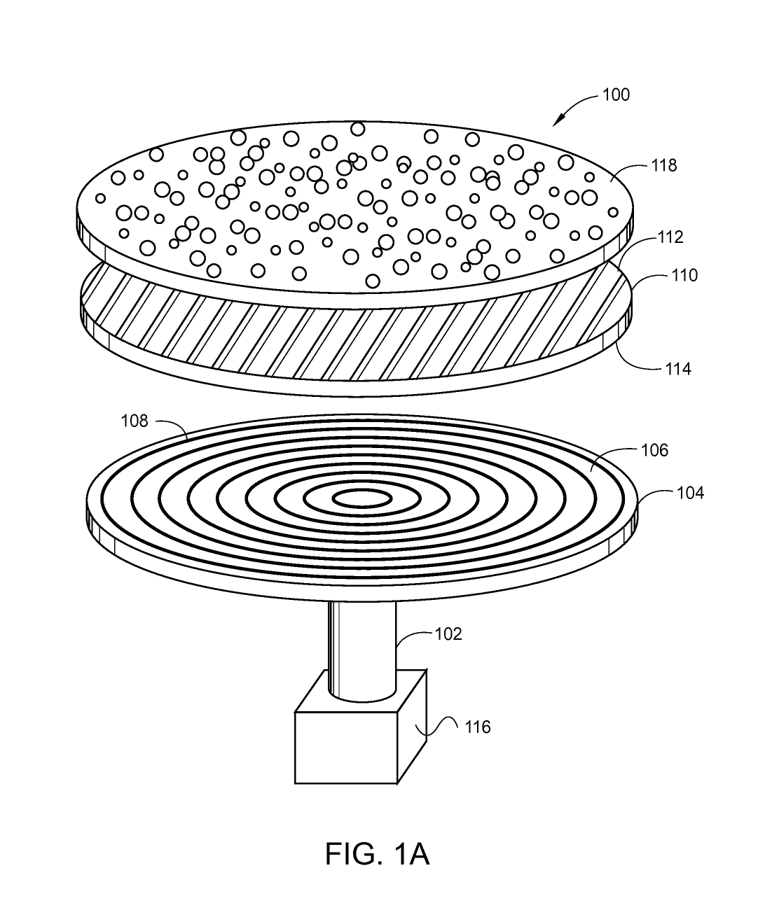

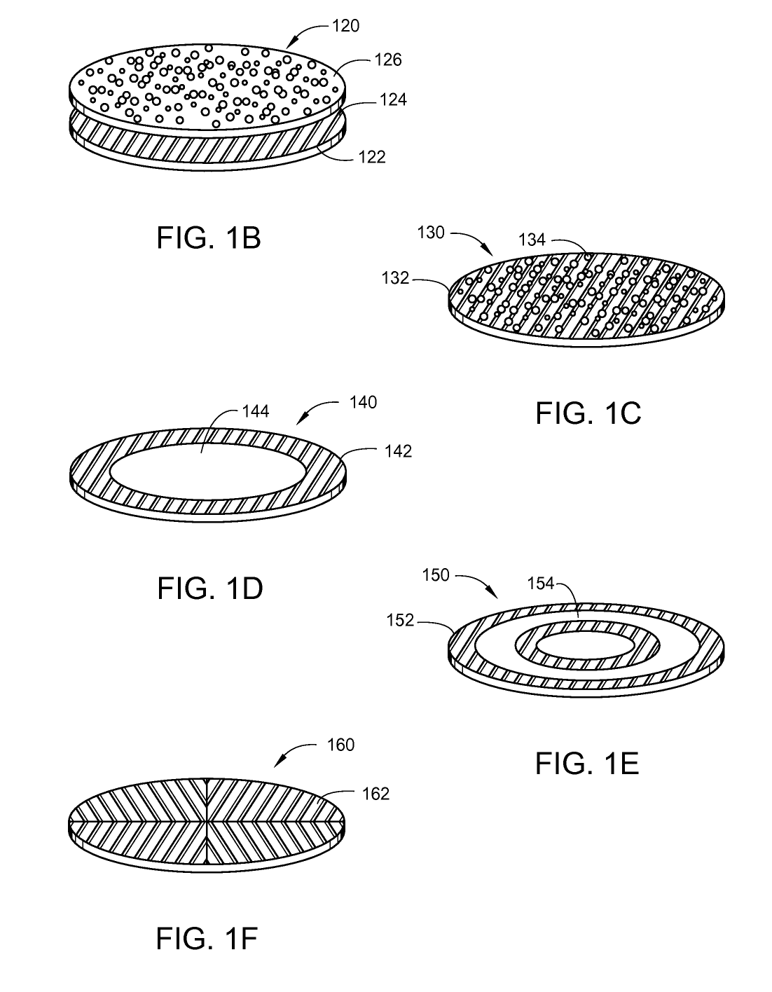

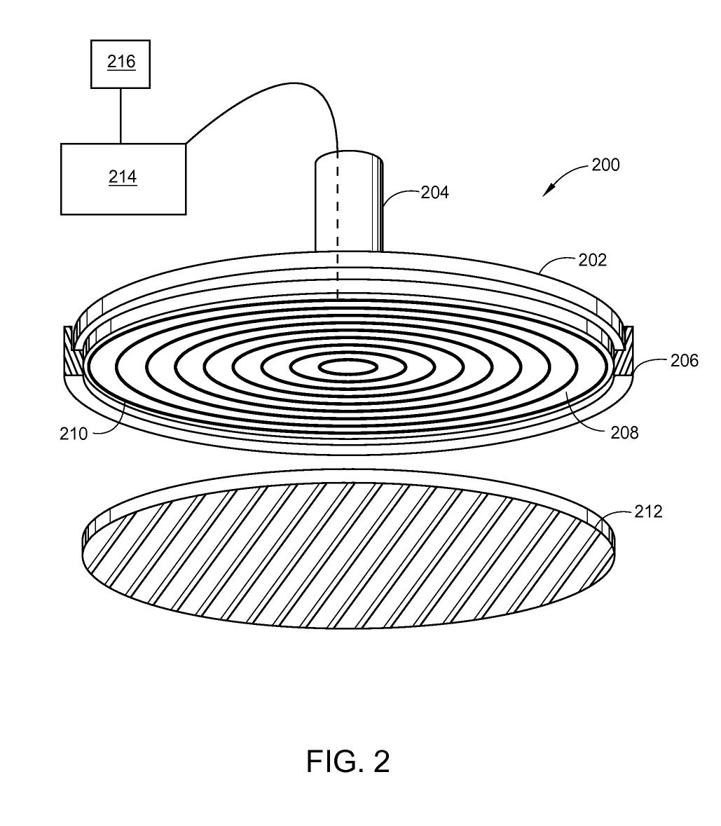

FIG. 1A is a top plan view of a polishing platen 100, according to one embodiment. The polishing platen 100 is generally part of a larger CMP system (not shown). The polishing platen 100 comprises a table 104 in connection with a rod 102. The rod 102 is coupled to a motor 116. The motor 116 rotated the rod 102 to rotate the table 104 based on the axis of the rod 102. The table 104 has a first surface 106 opposite a second surface (not shown). The first surface 106 can be an upper surface, when the table 104 is presented in a horizontal design. The first surface 106 can be connected with one or more magnetic field generators 108. The magnetic field generators 108 can be any composition or device capable of producing a magnetic field. In one embodiment, the magnetic field generators 108 are electromagnets.

In this embodiment, a magnetic-responsive composite 110 can be positioned over the table 104. The magnetic-responsive composite 110 can be in direct contact with the magnetic field generators 108 or in magnetic communication with the magnetic field generators 108. The magnetic-responsive composite 110 is at least partially composed of a ferromagnetic material. Suitable ferromagnetic materials for use in the magnetic-responsive composite include but are not limited to cobalt, iron, nickel, composites thereof or combinations thereof. The magnetic-responsive composite 110 further includes a flexible matrix, thus allowing for the ferromagnetic material to respond to the magnetic field. In one example, the flexible matrix includes polysiloxane. The magnetic-responsive composite 110 has a first surface 112.

The magnetic-responsive composite 110 can be between about 1 and about 100 mils thick. The magnetic-responsive composite 110 can be disposed over at least a portion of the surface of the polishing platen 100, such as the first surface 106. The magnetic-responsive composite 110 can be of an unequal thickness or unequal composition such that one portion of the magnetic-responsive composite 110 is more or less responsive to a magnetic field than another portion of the magnetic-responsive composite 110. The magnetic-responsive composite 110 can include both magnetically responsive regions magnetically inert regions such that only portions of the magnetic-responsive composite 110 are responsive to a magnetic field. Further, the concentration of the ferromagnetic material disposed in the magnetic-responsive composite 110 may vary. In one example, where the magnetic-responsive composite 110 is separated into quadrants, the first quadrant can have a first amount of a ferromagnetic material disposed within the matrix, the second quadrant can then have a second amount of a ferromagnetic material, which is between 1% and 100% of the first amount, disposed with the matrix. The third and fourth quadrants can then have a third and fourth amount, each of the third and fourth amount being between 1% and 100% of the first amount, disposed with the matrix. The varying quantities are not necessarily separated into quadrants and can be any known shape. Further, the ferromagnetic material used need not be the same between across different regions of the magnetic-responsive composite 110. In one example, a first portion of the magnetic-responsive composite 110 uses cobalt, a second portion uses iron and a third portion uses CrO₂.

A pad 118 can be positioned over the magnetic-responsive composite 110. Shown here, the pad 118 is positioned on the first surface 112 of the magnetic-responsive composite 110. The positioning of the pad 118 with respect to the magnetic-responsive composite 110 is not limiting, however. In another embodiment, the pad 118 and the magnetic-responsive composite 110 are the same structure, which is positioned on the first surface 106 of the table 104. FIGS. 1B-1F depict various examples of possible formations for the magnetic-responsive composite. The magnetic-responsive composite can include at least one portion which is responsive to a magnetic field. Thus, there are various combinations or permutations of the above design which can achieve the result of localized control of applied force on the substrate during the CMP process.

FIG. 1B depicts a magnetic-responsive stack 120 according to one embodiment. In this embodiment, the magnetic-responsive stack 120 includes a magnetic-responsive composite 122 with a first surface 124 and a polishing pad 126. The first surface 124 shown here is configured to support the polishing pad 126 for polishing of a substrate (not shown). The polishing pad can be made of cast and sliced polyurethane (or other polymers) with a filler, a urethane coated felt, a fixed abrasive pad or other suitable material. An example polishing pad has a thickness of approximately 50 mils (about 1.2 mm), a hardness of 70 Shore D, a density of 0.96 g/cc, and a tensile of 3500 psi. The polishing pad 126 can be made of a porous polyurethane material and can have pores and/or grooves.

When the magnetic field generators 108 generate a magnetic field, the magnetic-responsive composite 122 will change shape in response to the magnetic field. The change of shape is translated to the overlying polishing pad 126 to increase force applied at one or more areas of the substrate during CMP processing.

FIG. 1C depicts a magnetic-responsive stack 130 according to another embodiment. The magnetic-responsive stack 130 includes the magnetic-responsive composite 132 with a plurality of polishing components 134 formed therein. As described above, when the magnetic field generators 108 generate a magnetic field, the magnetic-responsive composite 132 will change shape in response to the magnetic field. The polishing components 134 are integrated into the magnetic-responsive composite 132, thus requiring no translation of force from the magnetic-responsive composite 122 to the polishing pad 126, as shown in FIG. 1B. The polishing components 134 are directly adjusted by the magnetic field.

FIG. 1D depicts a magnetic-responsive composite 140 according to one embodiment. The magnetic-responsive composite 140 is shown here with a magnetic-responsive region 142 and a magnetic inert region 144. The magnetic-responsive region 142 will change shape upon receiving a magnetic field from the magnetic field generators 108. However, the magnetic inert region 144 is largely unaffected by the magnetic field. Thus, the change in shape caused by the magnetic field to the magnetic-responsive composite 140 will be limited to the magnetic-responsive region 142, to create another level of control on the force applied.

FIG. 1E depicts a magnetic-responsive composite 150 according to another embodiment. The magnetic-responsive composite 150 is shown here with a plurality of magnetic-responsive regions 152 and a magnetic inert region 154. The magnetic-responsive region 152 will change shape upon receiving a magnetic field from the magnetic field generators 108. However, the magnetic inert region 154 is largely unaffected by the magnetic field. Of note, is that the change in shape from a specific magnetic-responsive region 152 may be different than the change in shape from other magnetic-responsive regions 152. In one example, the first magnetic-responsive region 152 may bow with respect to the table 104 in the presence of the magnetic field, while the second magnetic response region 152 may flex with respect to the table 104 in the presence of the magnetic field. Thus, the change in shape of the composite 150 caused by the magnetic field interacting with the magnetic-responsive composite 150 will be dictated by how each of the magnetic-responsive region 152 react to the magnetic fields relative to a neighboring magnetic-responsive region 152.

FIG. 1F depicts a magnetic-responsive composite 160 according to another embodiment. The magnetic-responsive composite 160 is depicted in FIG. 1F is divided into a plurality of magnetic-responsive portions 162, shown as four magnetic-responsive portions 162. The magnetic-responsive portions 162 may be in any shape, shown here as quadrants. Each of the magnetic-responsive portions 162 may respond independently of each other portion, either as measured by intensity or type. In the example here, the first quadrant may bow at a first intensity, the second quadrant may flex at a first intensity, the third quadrant may bow at a second intensity and the fourth quadrant may flex at a second intensity. The second intensity can be an intensity either greater than or less than the first intensity.

The polishing pad described above, or elements thereof, are not depicted in FIGS. 1D-1F for sake of clarity and brevity. However, it is understood that the polishing pad or components thereof, as described with reference to FIGS. 1A-1C, can be beneficially incorporated into the magnetically responsive composites described in FIGS. 1D-1F, without further recitation.

FIG. 2 depicts an exploded bottom perspective view of a polishing head 200, according to one embodiment. The polishing head 200 includes a platform 202 and a rod 204. The platform 202 is connected with a retaining ring 206. The retaining ring 206 acts in conjunction with the platform 202 to hold and rotate a substrate against a polishing pad. The platform 202 can have a first surface 208 in connection with one or more magnetic field generators 210. The magnetic field generators 210 can be formed in the first surface 208 and surrounded by the retaining ring 206.

A magnetic-responsive composite 212 can be positioned on or in the polishing head 200. In one embodiment, the magnetic-responsive composite 212 is positioned on the first surface 208 of the platform 202. The magnetic-responsive composite 212 can be a magnetic-responsive composite as described with reference to FIGS. 1A-1F. When the magnetic field generators 210 generate a magnetic field, the magnetic-responsive composite 212 will change shape in response to the magnetic field. The change of shape is translated to an overlying substrate (not shown) to increase or decrease force applied at one or more areas of the substrate during CMP processing.

The magnetic field generators 210 are connected with a power source 214. The power source 214 provides power to the magnetic field generators 210. Further, the power source 214 is switchable, such that the magnetic field, produced by the magnetic field generators 210, can be turned on and off in a controllable fashion. The power source 214 is in connection with a controller 216. The controller 216 can be operated by a set of predesignated commands, by individual user control or combinations thereof to control the power source 214, the motor 116 and other components. Though described with reference to the polishing head 200, the power source 214 is equally applicable to other embodiments without further recitation.

Advantageously, the magnetic-responsive composite allows of localized control of the force applied between the substrate and the polishing pad during the CMP operation. This location specific control allows for more uniform polishing and avoidance of WIWNU.

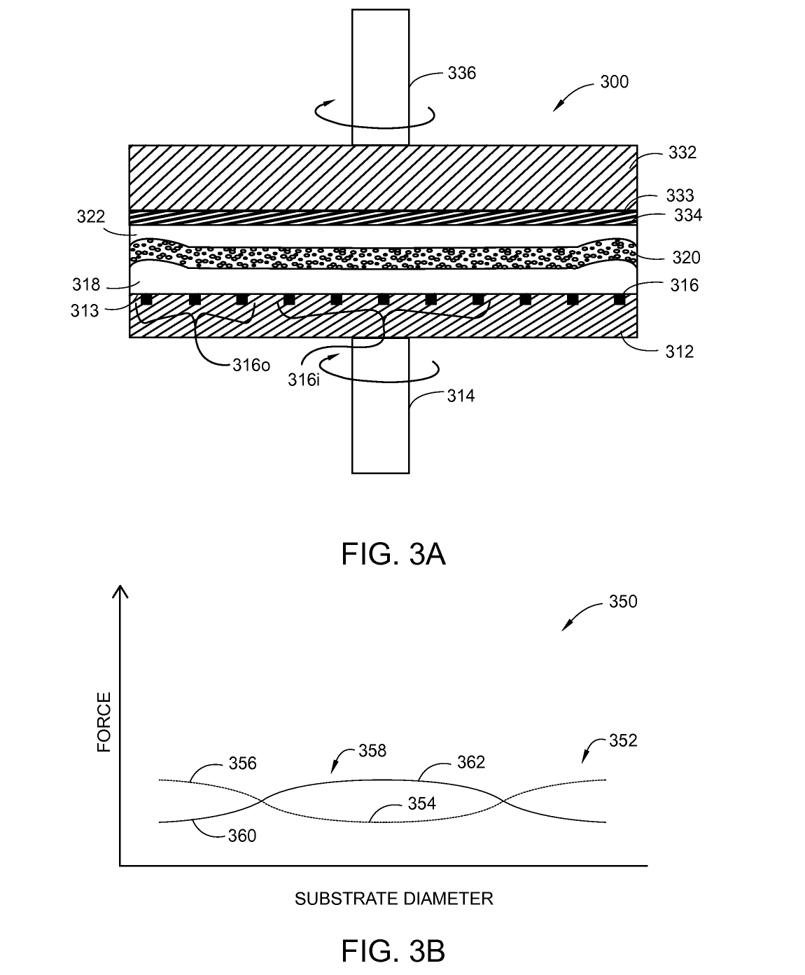

FIG. 3A depicts a side sectional view of a polishing system 300, according to embodiments herein. The size and shape of components of the polishing system 300 described herein are exaggerated to assist in explanation and are not limiting of possible embodiments. The polishing system 300 includes a polishing platen 310. Shown here, the polishing platen 310 includes a table 312. The table 312 includes a first surface 313 with one or more magnetic field generators 316 formed thereon. Opposite the magnetic field generators 316 is a rod 314, which supports and rotates the table 312 and the magnetic field generators 316. On the first surface 313 is a magnetic-responsive composite 318. The magnetic-responsive composite 318 can be composed as described with reference to FIGS. 1A-1F or other suitable configuration. The polishing pad 320 is disposed on the surface of the magnetic-responsive composite 318. The polishing pad 320 can be composed as described in FIG. 1A or in another suitable configuration. As previously described, the polishing pad 320 can either be an independent article or integrated with the magnetic-responsive composite 318 as a replaceable assembly.

Positioned opposite the polishing platen 310 is a polishing head 330. The polishing head 330 includes a platform 332 and a rod 336. The platform 332 has a first surface 333. Retained on the first surface 333 is a substrate 334. The substrate 334 can be held in position by a vacuum delivered through the first surface 333. In one embodiment, the vacuum is delivered through a membrane with a deflected shape. The rod 336 supports and rotates the platform 332 and the substrate 334.

In operation, the substrate 334 is positioned against the polishing pad 320. Both the polishing head 330 and the polishing platen 310 are rotated for the polishing process. During polishing, the substrate 334 is pressed against the polishing pad 320, while a slurry 322 is deposited in a continuous fashion on the polishing pad 320. The slurry 322 can comprise silica (and/or other abrasives) suspended in a mild etchant, such as potassium or ammonium hydroxide. The combination of chemical reaction from the slurry 322 and mechanical buffing from the polishing pad 320 removes vertical inconsistencies on the surface of the substrate, thereby forming an extremely flat surface.

At known points of non-uniformity, such as determined by scanning prior to positioning the substrate in the CMP system or as determined during processing by in-situ detection sensors, the magnetic field generators 316 can be activated to produce a magnetic field. As illustrated in FIG. 3, the magnetic field generators 316 at the edge of the polishing platen 310 have been activated. The presence of the magnetic field at the edge of the platen can then cause a change in shape of the portion of the magnetic-responsive composite 318 which either abuts or is proximate the energized magnetic field generator 316. This change in shape of the magnetic-responsive composite 318 causes a corresponding change in shape in the polishing pad 320. The change in shape in the polishing pad 320 causes a change in the amount of force applied at one or more points on the substrate 334 passing over the deformed pad. The increased localized pressure from the magnetic-responsive composite 318 prevents localized non-uniformity on the substrate 334 after polishing is complete.

The magnetic-responsive composite 318 can be configured to apply localized force to different regions of the polishing pad 320. In the embodiment of FIG. 3A, to the deformed portions of the polishing pad 320 apply a different level of force than portions of the polishing pad 320 over non-deformed regions. The magnetic field generators 316 can be configured to provide the one or more magnetic fields to separate portions of the magnetic-responsive composite 318. The magnetic-responsive composite 318 can be configured to contact the substrate 334 and apply localized force to at least one portion of the substrate 334 in response to at least one of the one or more magnetic fields.

In further embodiments, the magnetic-responsive composite 318 can be separated into a plurality of responsive portions (shown with reference to FIG. 1F), and each of the responsive portions are configured to change shape in response to the one or more magnetic fields independent of each other responsive portion. Though the polishing pad 320 is depicted as being approximately the same size at the substrate 334, it is understood that the positioning and size of the polishing pad 320 may be smaller or larger based on the needs of the user, the design of the system or both.

FIG. 3B depicts a force diagram 350 of the force applied by the magnetic-responsive composite 318 in the presence of one or more magnetic fields. The force diagram 350 shows a depiction of force in relation to the position on the substrate diameter in the embodiment shown in FIG. 3A. A first force curve 352 and a second force curve 358 are depicted in relation to the a first group of magnetic field generators 316 and a second group of magnetic field generators 316 (shown with relation to FIG. 3A), respectively.

During normal operation, the force applied between the polishing pad 320 and the substrate 334 can include a first baseline force 354. The first baseline force 354 is the force that exists between the polishing pad 320 and the substrate 334 during normal polishing without a conformational shift at the magnetic-responsive composite 318. When the first group of magnetic field generators 316 receive power from a power source (shown with reference to FIG. 2), the magnetic field generators 316 produce a magnetic field which causes a change in the shape of the magnetic-responsive composite 318. The magnetic-responsive composite 318 then applies a first force 356 related to the area of the magnetic field, Since the magnetic field generators 316 are located at the perimeter of the substrate 334, the conformational shift and the force subsequently applied is also at the perimeter.

In an embodiment where the second group of magnetic field generators 316 are used, the force applied between the polishing pad 320 and the substrate 334 can include a second baseline force 360. The second baseline force is the force that exists between the polishing pad 320 and the substrate 334 during normal polishing without a conformational shift at the magnetic-responsive composite 318. When the second group of magnetic field generators 316 receive power from a power source (shown with reference to FIG. 2), the magnetic field generators 316 produce a magnetic field which causes a change in the shape of the magnetic-responsive composite 318. The magnetic-responsive composite 318 then applies a second force 362 related to the area of the magnetic field, Since the magnetic field generators 316 are located in the center of the substrate 334, the conformational shift and the force subsequently applied is also at the perimeter of the substrate 334.

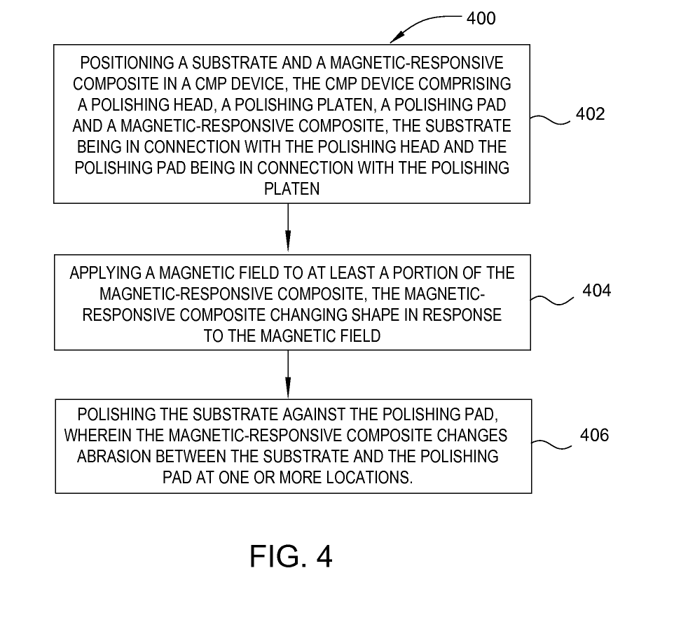

FIG. 4 is a block diagram of a method 400 of polishing a substrate according to one embodiment. The method 400 begins with positioning a substrate and a magnetic-responsive composite in a CMP device, at element 402. The CMP device can include a polishing head, a polishing platen, a polishing pad and a magnetic-responsive composite. The polishing head, the polishing platen, the polishing pad and the magnetic-responsive composite can have the same composition and structure as described with reference to FIGS. 1-3. The substrate is in connection with the polishing head. In one embodiment, the substrate is positioned on the polishing head. In another embodiment, the substrate is positioned on a magnetic-responsive composite which is on the polishing head. The polishing pad is positioned in connection with the polishing platen. In one embodiment, the polishing pad is positioned on the polishing platen. In another embodiment, the polishing pad is positioned on a magnetic-responsive composite which is on the polishing platen.

A magnetic field can then be applied to at least a portion of the magnetic-responsive composite, at element 404. The polishing head, the polishing platen or both may have one or more magnetic field generators formed therein. The magnetic field generators generating one or more magnetic fields. The magnetic-responsive composite can then change shape in response to the magnetic fields. In an embodiment with the magnetic-responsive composite formed in contact with the polishing head, magnetic field will cause a change in shape of the magnetic-responsive composite. The magnetic-responsive composite then translates the change in shape to the substrate. In an embodiment with the magnetic-responsive composite formed in contact with the polishing platen, magnetic field will cause a change in shape of the magnetic-responsive composite. The magnetic-responsive composite then translates the change in shape to the polishing pad.

The substrate is then polished against the polishing pad, at element 406. In CMP processes, the surface layer is abraded using the pad and the applied slurry, as described above with reference to FIG. 3. Abrasion is a function of the friction between two substances. Due to the change in shape at the magnetic responsive element, friction between the polishing pad and the substrate either increases or decreases at one or more points on the substrate. Thus, the change in shape creates a change in abrasion between the polishing pad and the substrate at one or more locations.

While the foregoing is directed to embodiments of the present invention, other and further embodiments of the invention may be devised without departing from the basic scope thereof, and the scope thereof is determined by the claims that follow.

1. A device, comprising:
a support with one or more magnetic field generators formed therein, wherein the magnetic field generators produce a magnetic field; and
a magnetic-responsive composite in connection with the magnetic field generators, wherein the magnetic-responsive composite changes shape in response to the magnetic field.

2. The device of claim 1, wherein the magnetic-responsive composite comprises a ferrogel.

3. The device of claim 1, wherein the magnetic-responsive composite comprises iron particles disposed in a polysiloxane matrix.

4. The device of claim 1, further comprising a polishing pad, wherein the magnetic-responsive composite is formed between the polishing pad and the support.

5. The device of claim 1, further comprising a polishing pad, wherein the polishing pad includes the magnetically-responsive composite.

6. The device of claim 1, wherein the support is a polishing head.

7. The device of claim 6, further comprising a retaining ring, wherein the magnetic field generators are positioned on the surface of the polishing head and surrounded by the retaining ring.

8. The device of claim 1, wherein the support is a polishing platen.

9. A device, comprising:
a polishing platen;
a magnetic-responsive composite formed on the surface of the polishing platen;
one or more magnetic field generators in magnetic connection with the magnetic-responsive composite, the magnetic field generators producing one or more magnetic fields; and
a polishing pad formed in connection with the magnetic-responsive composite, the polishing pad changing shape with the magnetic-responsive composite.

10. The device of claim 9, wherein the magnetic-responsive composite comprises a ferrogel.

11. The device of claim 9, wherein the magnetic-responsive composite comprises iron particles disposed in a polysiloxane matrix.

12. The device of claim 9, wherein the magnetic-responsive composite is formed between the polishing pad and the polishing platen.

13. The device of claim 9, wherein the polishing pad includes the magnetically-responsive composite.

14. The device of claim 9, wherein the magnetic-responsive composite is separated into a plurality of responsive portions, and wherein each of the responsive portions respond to the one or more magnetic fields independent of each other responsive portion.

15. The device of claim 9, wherein the magnetic field generators are embedded in the surface of the support.

16. A method of polishing a substrate, comprising:
positioning a substrate and a magnetic-responsive composite in a CMP device, the CMP device comprising a polishing head, a polishing platen, a polishing pad and a magnetic-responsive composite, the substrate being in connection with the polishing head and the polishing pad being in connection with the polishing platen;
applying a magnetic field to at least a portion of the magnetic-responsive composite, the magnetic-responsive composite changing shape in response to the magnetic field; and
polishing the substrate against the polishing pad, wherein the magnetic-responsive composite changes abrasion between the substrate and the polishing pad at one or more locations.

17. The method of claim 16, wherein the magnetic-responsive composite is formed between the polishing pad and the polishing platen.

18. The method of claim 16, wherein the magnetic-responsive composite is formed between the substrate and the polishing head.

19. The method of claim 16, wherein the magnetic-responsive composite is separated into a plurality of responsive portions, and each of the responsive portions are configured to change shape in response to the one or more magnetic fields independent of each other responsive portion.

20. The method of claim 16, wherein the magnetic-responsive composite and the polishing pad are combined.
